(19) United States
(12) Patent Application Publication
(10) Pub. No.: US 2012/0312799 A1
(43) Pub. Date: Dec. 13, 2012

(54) ELECTRIC SOLDERING IRON AND METHOD FOR HEATING THE ELECTRIC SOLDERING IRON

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/426,611

(22) Filed: Mar. 22, 2012

(30) Foreign Application Priority Data
Jun. 9, 2011 (CN) 201110153963.1

(51) Int. Cl. H05B 3/42

(52) U.S. Cl. 219/241

(57) ABSTRACT

An electric soldering iron includes a proximity sensor and a processing unit. The processing unit electronically connects to the proximity sensor, a timer, and a power control unit. The power control unit connects to a heating circuit. The proximity sensor senses presence of a nearby user. The processing unit controls the timer to count a time duration when the proximity sensor does not sense the presence of the nearby user. If the non-sensing continues for a certain period the electric soldering iron is switched to less power, and if the non-sensing continues for an additional period of time, the electric soldering iron is switched off altogether.

### BACKGROUND

1. Technical Field

Embodiments of the present disclosure relate to the field of electrical soldering, and greater particularly, to an electric soldering iron and a method for heating the electric soldering iron.

2. Description of Related Art

Electric soldering irons are used in production, testing, and maintaining of electric products. However, powering off such electric soldering irons after use is often neglected, which accelerates oxidation of iron heads of the electric soldering irons and reduces lifetime of the electric soldering irons. Therefore, it is desired an improved electric soldering iron and a method for heating the electric soldering iron.

### BRIEF DESCRIPTION OF THE DRAWINGS

FIG. 1 is a block diagram of one embodiment of an electric soldering iron.

FIG. 2 is a flowchart of one embodiment of a method for heating the electric soldering iron of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

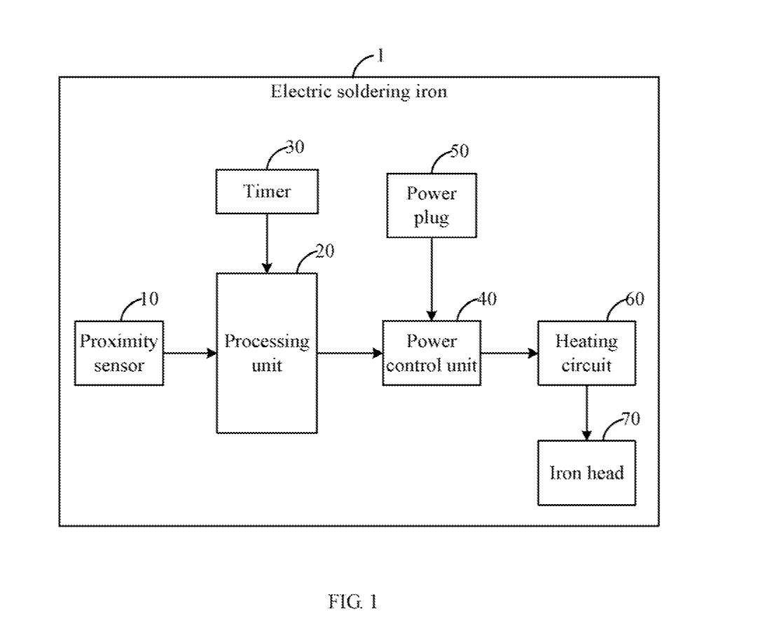

FIG. 1 is a block diagram of one embodiment of an electric soldering iron 1. In the embodiment, the electric soldering iron 1 includes a proximity sensor 10, a processing unit 20, a timer 30, a power control unit 40, a power plug 50, a heating circuit 60, and an iron head 70. The proximity sensor 10 is configured for sensing presence of a nearby user of the electric soldering iron 1 according to a sensing distance between the user and the electric soldering iron 1. For example, a maximum sensing distance that the proximity sensor 10 can sense may be fifty centimeters. The proximity sensor 10 may be an infrared sensor in one example. If the proximity sensor 10 senses the presence of the nearby user, indicating that the electric soldering iron 1 is in use, the proximity sensor 10 sends a sensing signal to the processing unit 20.

The processing unit 20 includes a first input terminal, a second input terminal, and an output terminal. The proximity sensor 10 is electronically connected to the first input terminal, and the timer 30 is electronically connected to the second input terminal. The processing unit 20 may be a single-chip microcomputer.

The power control unit 40 includes a control pin, an input pin, and an output pin. The output terminal of the processing unit 20 is electronically connected to the control pin of the power control unit 40. The power plug 50 is connected to the input pin of the power control unit 40, for connecting the electric soldering iron 1 to an external power source, such as a power supply. The heating circuit 60 is connected to the output pin of the power control unit 40. The heating circuit 60 is further connected to the iron head 70 for heating the iron head 70. The power control unit 40 is configured for controlling the heating circuit 60 to heat the iron head 70 according to control signals from the processing unit 20. The power control unit 40 may be a power control circuit that consists of relays and diodes. The iron head 70 may consist of heating wires or positive temperature coefficient thermistors.

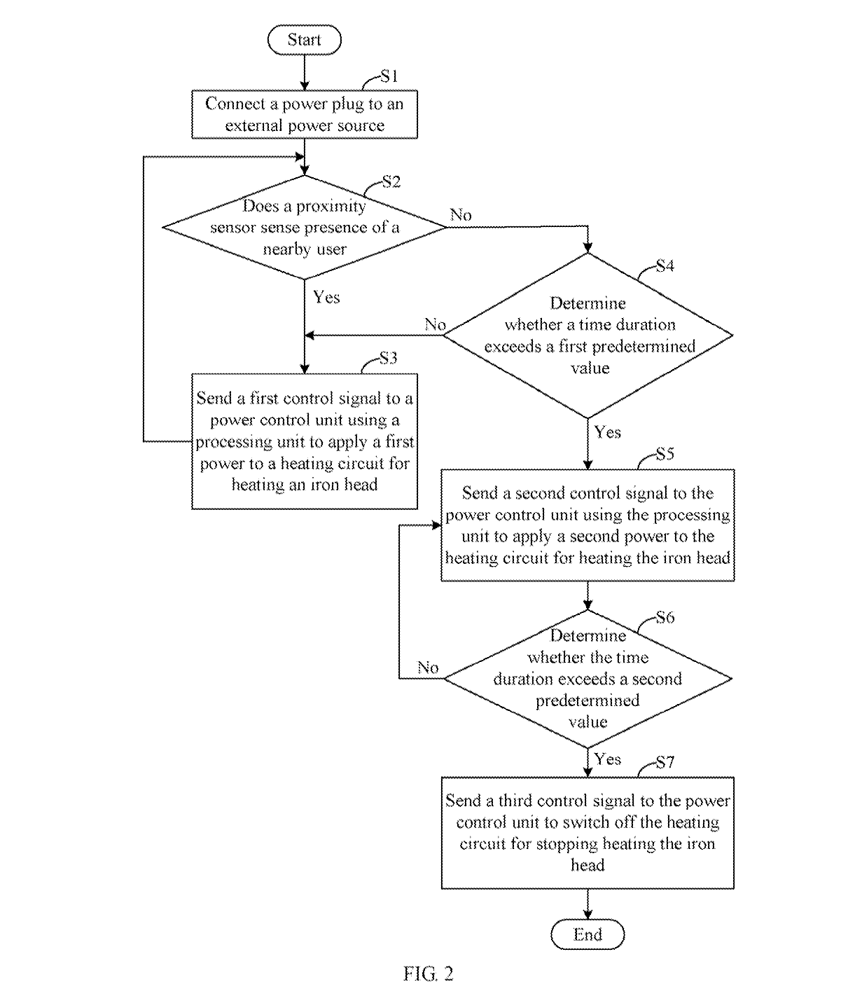

FIG. 2 is a flowchart of one embodiment of a method for heating the electric soldering iron 1 of FIG. 1. Depending on the embodiment, additional blocks may be added, others removed, and the ordering of the blocks may be changed.

In block S1, the power plug 50 connects to an external power source for starting the electric soldering iron 1. In one embodiment, the external power source is a power supply that provides power for the electric soldering iron 1.

In block S2, the proximity sensor 10 senses presence of a nearby user of the electric soldering iron 1 according to a sensing distance between the user and the electric soldering iron 1. If the proximity sensor 10 senses the presence of the nearby user, the proximity sensor 10 generates a sensing signal and sends the sensing signal to the processing unit 20, and block S3 is implemented. If the proximity sensor 10 does not sense the presence of the nearby user, block S4 is implemented.

In block S3, the processing unit 20 sends a first control signal to control the power control unit 40 to apply a first power to the heating circuit 60 for heating the iron head 70. Meanwhile, as long as the proximity sensor 10 continuously senses the presence of a nearby user of the electric soldering iron 1, block S2 is repeated.

In block S4, the processing unit 20 determines whether a time duration exceeds a first predetermined value (for example, five minutes). In one embodiment, the time duration is defined as a time since the most recent sensing signal is received from the proximity sensor 10. If the time duration exceeds the first predetermined value, block S5 is implemented. Otherwise, if the time duration does not exceed the first predetermined value, the block S3 is repeated.

In the embodiment, the processing unit 20 sends an enabling signal to the timer 30 to count the time duration when no sensing signal is received by the processing unit 20. When the processing unit 20 receives the sensing signal, the processing unit 20 sends a disabling signal to the timer 30 to stop timing and reset the time duration to zero, and block S3 is repeated to maintain the heating of the iron head 70. The processing unit 20 acquires the time duration from the timer 30. If the time duration timed by the timer 30 exceeds the first predetermined value, the processing unit 20 determines that the electric soldering iron 1 is not being used and block S5 is implemented.

In block S5, the processing unit 20 sends a second control signal to control the power control unit 40 to apply a second power to the heating circuit 60 for heating the iron head 70. In the embodiment, the second power is less in quantum than the first power. For example, the second power is half of the first power. That is, the iron head 70 is heated at a more power (i.e., the first power) in block S3, and the iron head 70 is heated at a less power (i.e., the second power) in block S5, so that the electric soldering iron 1 can be in a power-saving mode to save power.

In block S6, the processing unit 20 determines whether the time duration exceeds a second predetermined value (e.g., ten minutes). In the embodiment, the second predetermined value is greater than the first predetermined value, for example, the second predetermined value is twice of the first predetermined value. If the time duration exceeds the second predetermined value, block S7 is implemented. Otherwise, if the time duration does not exceed the second predetermined value, the block S5 is repeated.

In block S7, the processing unit 20 sends a third control signal to control the power control unit 40 to switch off the heating circuit 60 altogether to stop any heating of the iron head 70, so that the electric soldering iron 1 can be powered off automatically.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electric soldering iron, comprising:
a proximity sensor configured for sensing presence of a nearby user;
a processing unit electronically connected to a timer and the proximity sensor;
a heating circuit and an iron head;
a power control unit connecting to the heating circuit and the processing unit;
the processing unit operable to control the timer to count a time duration when the proximity sensor does not sense the presence of the nearby user, and control the power control unit to apply power to the heating circuit for heating the iron head according to the time duration.

2. The electric soldering iron of claim 1, wherein the proximity sensor sends a sensing signal to the processing unit when the proximity sensor senses the presence of the nearby user, the processing unit sends a first control signal to the power control unit when the sensing signal is received, and the power control unit applies a first power to the heating circuit for heating the iron head when the first control signal is received the processing unit.

3. The electric soldering iron of claim 2, wherein the processing unit sends an enabling signal to the timer to count the time duration when no signal is received from the proximity sensor, and sends a disabling signal to the timer to stop timing and reset the timer to zero when the sensing signal is received from the proximity sensor.

4. The electric soldering iron of claim 3, wherein the processing unit sends a second control signal to the power control unit when the time duration exceeds a first predetermined value, and the power control unit applies a second power to the heating circuit for heating the iron head when the second control signal is received from the processing unit.

5. The electric soldering iron of claim 4, wherein the second power is less than the first power.

6. The electric soldering iron of claim 4, wherein the processing unit sends a third control signal to the power control unit when the time duration exceeds a second predetermined value, and the power control unit switches off the heating circuit for stopping heating the iron head when the third control signal is received from the processing unit.

7. The electric soldering iron of claim 6, wherein the second predetermined value is greater than the first predetermined value.

8. The electric soldering iron of claim 1, wherein the proximity sensor is an infrared sensor.

9. The electric soldering iron of claim 1, wherein the processing unit is a single-chip microcomputer.

10. The electric soldering iron of claim 1, wherein the power control unit is a power control circuit that consists of relays and diodes.

11. A method for heating an electric soldering iron, the method comprising:
sensing presence of a nearby user using a proximity sensor;
controlling a timer to count a time duration when the proximity sensor does not sense the presence of the nearby user; and
controlling a power control unit to apply power to a heating circuit of the electric soldering iron for heating an iron head of the electric soldering iron through a processing unit according to the time duration.

12. The method of claim 11, further comprising:
sending a sensing signal to the processing unit using the proximity sensor when the proximity sensor senses the presence of the nearby user;
sending a first control signal to the power control unit using the processing unit when the sensing signal is received from the proximity sensor; and
applying a first power to the heating circuit for heating the iron head using the power control unit when the first control signal is received from the processing unit.

13. The method of claim 12, further comprising:
sending an enabling signal to the timer to count the time duration when no signal is received from the proximity sensor by the processing unit; and
sending a disabling signal to the timer to stop timing and reset the timer to zero when the sensing signal is received from the proximity sensor by the processing unit.

14. The method of claim 13, wherein the processing unit sends a second control signal to the power control unit when the time duration exceeds a first predetermined value, and the power control unit applies a second power to the heating circuit for heating the iron head when the second control signal is received from the processing unit.

15. The method of claim 14, wherein the second power is less than the first power.

16. The method of claim 14, wherein the processing unit sends a third control signal to the power control unit when the time duration exceeds a second predetermined value, and the power control unit switches off the heating circuit for stopping heating the iron head when the third control signal from the processing unit.

17. The method of claim 16, wherein the second predetermined value is greater than the first predetermined value.
